(19) United States
(12) Patent Application Publication
(10) Pub. No.: US 2006/0218383 A1
(43) Pub. Date: Sep. 28, 2006

(54) Integrated circuit device

(75) Inventor: Makoto Kudo, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/373,879

(22) Filed: Mar. 10, 2006

(30) Foreign Application Priority Data
Mar. 22, 2005 (JP) 2005-082049

(51) Int. Cl. G06F 9/44

(52) U.S. Cl. 712/225

(57) ABSTRACT

An integrated circuit device having a CPU which performs given processing based on an instruction code, and a coprocessor which performs given calculation processing based on data supplied from the CPU and outputs a calculation result to the CPU. The CPU includes an immediate value generation section which generates immediate data imm based on the instruction code and outputs the generated immediate data, and an immediate data supply line IMC used to supply the immediate data imm output from the immediate value generation section to the coprocessor.

Japanese Patent Application No. 2005-82049, filed on Mar. 22, 2005, is hereby incorporated by reference in its entirety.

### BACKGROUND OF THE INVENTION

The present invention relates to an integrated circuit device.

In recent years, various electronic instruments have been increasingly demanded along with an improvement in semiconductor technology. A central processing unit (CPU) for processing various types of control is generally provided in such electronic instruments. In order to provide a higher processing performance for an electronic instrument including a processor, it is known that a coprocessor which performs specific processing is provided in addition to the CPU. In this case, the processing can be performed at high speed by causing the coprocessor to perform processing in which the CPU is weak.

However, the CPU cannot supply information necessary for processing by the coprocessor at one time due to limitations to the bus which connects the CPU and the coprocessor. Therefore, since the CPU must supply necessary information to the coprocessor a number of times, an increase in the processing performance is hindered. In order to further increase the processing performance, it is necessary to increase the operating clock frequency or to increase the hardware scale. However, this hinders a reduction in power consumption and cost.

JP-A-2000-284962 discloses related-art technology in this field.

### SUMMARY

According to a first aspect of the invention, there is provided an integrated circuit device having a CPU which performs given processing based on an instruction code,

the CPU including:

a fetch section which fetches the instruction code;

a register file including a plurality of registers and first to nth (n is an integer greater than one) register select circuits each of which selects at least one arbitrary register from the registers and outputs a value stored in the selected register;

an immediate value generation section which generates immediate data based on the instruction code and outputs the generated immediate data;

an instruction code supply line used to supply the instruction code fetched by the fetch section to a coprocessor;

first to nth register file supply lines used to supply the output from at least one of the first to nth register select circuits of the register file to the coprocessor; and

an immediate data supply line used to supply the output from the immediate value generation section to the coprocessor;

each of the registers storing an address or data used for the given processing;

the fetch section outputting the fetched instruction code to the instruction code supply line;

the outputs from the first to nth register select circuits of the register file being output to the first to nth register file supply lines; and

the immediate value generation section outputting the immediate data to the immediate data supply line.

According to a second aspect of the invention, there is provided an integrated circuit device having a CPU which performs given processing based on an instruction code,

the CPU including:

an ALU which performs calculation processing based on the instruction code;

an ALU output supply line used to supply a calculation result of the ALU to a coprocessor; and

a flag data supply line used to supply an output from a flag register which stores flag data based on the calculation result of the ALU to the coprocessor;

the calculation result of the ALU being output to the ALU output supply line; and

the flag data stored in the flag register being output to the flag data supply line.

According to a third aspect of the invention, there is provided an integrated circuit device having a CPU which performs given processing based on an instruction code,

the CPU including:

an immediate value generation section which generates immediate data based on the instruction code and outputs the generated immediate data;

a lord store section which reads data from a memory or writes data into the memory;

an immediate data supply line used to supply the output from the immediate value generation section to a coprocessor; and

a load data supply line used to supply data read from the memory by the lord store section to the coprocessor;

the immediate value generation section outputting the immediate data to the immediate data supply line; and

the lord store section outputting the data read from the memory to the load data supply line.

According to a fourth aspect of the invention, there is provided an integrated circuit device having a CPU which performs given processing based on an instruction code,

the CPU including:

a fetch section which fetches the instruction code;

a register file including a plurality of registers and first to nth (n is an integer greater than one) register select circuits each of which selects at least one arbitrary register from the plurality of registers and outputs a value stored in the selected register;

an instruction code supply line used to supply the instruction code fetched by the fetch section to a coprocessor; and

first to nth register file supply lines used to supply the output from at least one of the first to nth register select circuits of the register file to the coprocessor;

each of the registers storing an address or data used for the given processing;

the fetch section outputting the fetched instruction code to the instruction code supply line; and

the outputs from the first to nth register select circuits of the register file being output to the first to nth register file supply lines.

According to a fifth aspect of the invention, there is provided an integrated circuit device having a CPU which performs given processing based on an instruction code,

the CPU including:

a register file including a plurality of registers; and

a fixed register data supply line used to supply an output from a register of the plurality of registers set as a fixed register to a coprocessor; and

the fixed register storing an address or data used for the given processing; and

a value stored in the fixed register being output to the fixed register data supply line.

According to a sixth aspect of the invention, there is provided an integrated circuit device having a CPU which performs given processing based on an instruction code,

the CPU including:

an immediate value generation section which generates immediate data based on the instruction code and outputs the generated immediate data; and

an immediate data supply line used to supply the output from the immediate value generation section to a coprocessor; and

the immediate value generation section outputting the immediate data to the immediate data supply line.

According to a seventh aspect of the invention, there is provided an integrated circuit device having a CPU which performs given processing based on an instruction code,

the CPU including:

an ALU which performs calculation processing based on the instruction code and outputs a calculation result; and

an ALU output supply line used to supply the calculation result of the ALU to a coprocessor; and

the calculation result of the ALU being output to the ALU output supply line.

According to an eighth aspect of the invention, there is provided an integrated circuit device having a CPU which performs given processing based on an instruction code,

the CPU including an ALU which performs calculation processing based on the instruction code;

the ALU including a flag register which stores flag data based on a calculation result;

the CPU including a flag data supply line used to supply an output from the flag register of the ALU to a coprocessor; and

the flag data stored in the flag register being output to the flag data supply line.

According to a ninth aspect of the invention, there is provided an integrated circuit device having a CPU which performs given processing based on an instruction code,

the CPU including:

a lord store section which reads data from a memory or writes data into the memory; and

a load data supply line used to supply data read from the memory by the lord store section to a coprocessor; and

the data read from the memory by the lord store section being output to the load data supply line.

According to a tenth aspect of the invention, there is provided an integrated circuit device having a CPU which performs given processing based on an instruction code,

the CPU including:

a fetch section which fetches the instruction code;

a decode control section which decodes the instruction code fetched by the fetch section and outputs a control signal; and

a control signal supply line used to supply the control signal output from the decode control section to a coprocessor; and

the control signal output from the decode control section being output to the control signal supply line.

According to an eleventh aspect of the invention, there is provided an integrated circuit device having a CPU which performs given processing based on an instruction code,

the CPU including:

a fetch section including a program counter; and

a count value supply line used to supply a count value output from the program counter to a coprocessor;

the fetch section fetching the instruction code based on the count value output from the program counter; and

the count value of the program counter being output to the count value supply line.

According to a twelfth aspect of the invention, there is provided an integrated circuit device having a CPU which performs given processing based on an instruction code, and a coprocessor which performs given calculation processing based on data supplied from the CPU and outputs a calculation result to the CPU,

the CPU including:

a register file including a plurality of registers, each of which holds an address or data used for the given processing, and first to nth (n is an integer greater than one) register select circuits, each of which selects at least one arbitrary register from the plurality of registers and outputs a value stored in the selected register; and

first to nth register file supply lines used to supply an output from at least one of the first to nth register select circuits of the register file to the coprocessor.

According to a thirteenth aspect of the invention, there is provided an integrated circuit device having a CPU which performs given processing based on an instruction code, and a coprocessor which performs given calculation processing based on data supplied from the CPU and outputs a calculation result to the CPU,

the CPU including:

an immediate value generation section which generates immediate data based on the instruction code and outputs the generated immediate data; and

an immediate data supply line used to supply the immediate data output from the immediate value generation section to the coprocessor.

According to a fourteenth aspect of the invention, there is provided an integrated circuit device having a CPU which performs given processing based on an instruction code, and a coprocessor which performs given calculation processing based on data supplied from the CPU and outputs a calculation result to the CPU,

the CPU including:

an ALU which performs calculation processing based on the instruction code; and

an ALU output supply line used to supply a calculation result of the ALU to a coprocessor.

According to a fifteenth aspect of the invention, there is provided an integrated circuit device having a CPU which performs given processing based on an instruction code, and a coprocessor which performs given calculation processing based on data supplied from the CPU and outputs a calculation result to the CPU,

the CPU including:

a lord store section which reads data from a memory or writes data into the memory; and

a load data supply line used to supply data read from the memory by the lord store section to the coprocessor.

### BRIEF DESCRIPTION OF THE SEVERAL VIEWS OF THE DRAWING

FIG. 1 is a block diagram showing an integrated circuit device according to one embodiment of the invention.

FIG. 2 is a block diagram showing an integrated circuit device and a CPU according to one embodiment of the invention.

FIG. 3 is a diagram showing connection between a CPU and a coprocessor according to one embodiment of the invention.

FIG. 4 is a block diagram showing a register file according to one embodiment of the invention.

FIGS. 5A and 5B are diagrams showing an instruction code according to one embodiment of the invention.

FIGS. 6A and 6B are diagrams showing product-sum calculation processing according to one embodiment of the invention.

FIGS. 7A and 7B are diagrams showing saturation processing according to one embodiment of the invention.

FIGS. 8A and 8B are diagrams showing calculation processing according to one embodiment of the invention.

FIGS. 9A and 9B are diagrams showing generation of an immediate value according to one embodiment of the invention.

FIG. 10 is a diagram showing a comparative example of one embodiment of the invention.

FIG. 11 is a diagram showing a modification according to one embodiment of the invention.

### DETAILED DESCRIPTION OF THE EMBODIMENT

The invention may provide an integrated circuit device which performs high-speed calculation processing and minimizes an increase in hardware scale.

According to one embodiment of the invention, there is provided an integrated circuit device having a CPU which performs given processing based on an instruction code,

the CPU including:

a fetch section which fetches the instruction code;

a register file including a plurality of registers and first to nth (n is an integer greater than one) register select circuits each of which selects at least one arbitrary register from the registers and outputs a value stored in the selected register;

an immediate value generation section which generates immediate data based on the instruction code and outputs the generated immediate data;

an instruction code supply line used to supply the instruction code fetched by the fetch section to a coprocessor;

first to nth register file supply lines used to supply the output from at least one of the first to nth register select circuits of the register file to the coprocessor; and

an immediate data supply line used to supply the output from the immediate value generation section to the coprocessor;

each of the registers storing an address or data used for the given processing;

the fetch section outputting the fetched instruction code to the instruction code supply line;

the outputs from the first to nth register select circuits of the register file being output to the first to nth register file supply lines; and

the immediate value generation section outputting the immediate data to the immediate data supply line.

In this embodiment, the CPU (central processing unit) can supply the instruction code, the immediate data, and the output from the register file to the coprocessor at one operating clock signal of the CPU, for example. Specifically, processing using the coprocessor can be performed at high speed. In the case where the coprocessor performs special product-sum calculation processing using the immediate data and the output from the register file, the CPU can supply the necessary information to the coprocessor at one clock signal, for example. The coprocessor can acquire the instruction code, the immediate data, and the output from the register file in a period in which the CPU performs another processing.

According to one embodiment of the invention, there is provided an integrated circuit device having a CPU which performs given processing based on an instruction code,

the CPU including:

an ALU which performs calculation processing based on the instruction code;

an ALU output supply line used to supply a calculation result of the ALU to a coprocessor; and

a flag data supply line used to supply an output from a flag register which stores flag data based on the calculation result of the ALU to the coprocessor;

the calculation result of the ALU being output to the ALU output supply line; and

the flag data stored in the flag register being output to the flag data supply line.

In this embodiment, the CPU can supply the calculation result of the ALU (arithmetic-and-logic unit) and the flag data based on the calculation result of the ALU to the coprocessor at one operating clock signal of the CPU, for example. Specifically, processing using the coprocessor can be performed at high speed. In the case where the coprocessor performs calculation processing using the calculation result of the ALU and the flag data of the ALU, the CPU can supply the necessary information to the coprocessor at one clock signal, for example. Therefore, saturation processing can be performed at high speed, for example. The coprocessor can acquire the calculation result of the ALU and the flag data in a period in which the CPU performs another processing.

According to one embodiment of the invention, there is provided an integrated circuit device having a CPU which performs given processing based on an instruction code,

the CPU including:

an immediate value generation section which generates immediate data based on the instruction code and outputs the generated immediate data;

a lord store section which reads data from a memory or writes data into the memory;

an immediate data supply line used to supply the output from the immediate value generation section to a coprocessor; and

a load data supply line used to supply data read from the memory by the lord store section to the coprocessor;

the immediate value generation section outputting the immediate data to the immediate data supply line; and

the lord store section outputting the data read from the memory to the load data supply line.

In this embodiment, the CPU can supply the immediate data generated by the immediate value generation section and the load data read from the memory by the lord store section to the coprocessor at one operating clock signal of the CPU, for example. Specifically, processing using the coprocessor can be performed at high speed. In the case where the coprocessor performs calculation processing using the immediate data and the load data, the CPU can supply the necessary information to the coprocessor at one clock signal, for example. The coprocessor can acquire the immediate data and the load data in a period in which the CPU performs another processing.

According to one embodiment of the invention, there is provided an integrated circuit device having a CPU which performs given processing based on an instruction code,

the CPU including:

a fetch section which fetches the instruction code;

a register file including a plurality of registers and first to nth (n is an integer greater than one) register select circuits each of which selects at least one arbitrary register from the plurality of registers and outputs a value stored in the selected register;

an instruction code supply line used to supply the instruction code fetched by the fetch section to a coprocessor; and

first to nth register file supply lines used to supply the output from at least one of the first to nth register select circuits of the register file to the coprocessor;

each of the registers storing an address or data used for the given processing;

the fetch section outputting the fetched instruction code to the instruction code supply line; and

the outputs from the first to nth register select circuits of the register file being output to the first to nth register file supply lines.

In this embodiment, the CPU can supply the instruction code and the output from the register file to the coprocessor at one operating clock signal of the CPU, for example. Specifically, processing using the coprocessor can be performed at high speed. The CPU can supply the necessary information to the coprocessor at one clock signal, for example. The coprocessor can acquire the instruction code and the output from the register file in a period in which the CPU performs another processing.

According to one embodiment of the invention, there is provided an integrated circuit device having a CPU which performs given processing based on an instruction code,

the CPU including:

a register file including a plurality of registers; and

a fixed register data supply line used to supply an output from a register of the plurality of registers set as a fixed register to a coprocessor; and

the fixed register storing an address or data used for the given processing; and

a value stored in the fixed register being output to the fixed register data supply line.

In this embodiment, the CPU can supply the output from the fixed register to the coprocessor at one operating clock signal of the CPU, for example. Specifically, processing using the coprocessor can be performed at high speed. The CPU can supply the necessary information to the coprocessor at one clock signal, for example. The coprocessor can acquire the output from the fixed register in a period in which the CPU performs another processing.

According to one embodiment of the invention, there is provided an integrated circuit device having a CPU which performs given processing based on an instruction code,

the CPU including:

an immediate value generation section which generates immediate data based on the instruction code and outputs the generated immediate data; and

an immediate data supply line used to supply the output from the immediate value generation section to a coprocessor; and

the immediate value generation section outputting the immediate data to the immediate data supply line.

In this embodiment, the CPU can supply the immediate data output from the immediate value generation section to the coprocessor at one operating clock signal of the CPU, for example. Specifically, processing using the coprocessor can be performed at high speed. The CPU can supply the necessary information to the coprocessor at one clock signal, for example. The coprocessor can acquire the immediate data output from the immediate value generation section in a period in which the CPU performs another processing.

According to one embodiment of the invention, there is provided an integrated circuit device having a CPU which performs given processing based on an instruction code,

the CPU including:

an ALU which performs calculation processing based on the instruction code and outputs a calculation result; and

an ALU output supply line used to supply the calculation result of the ALU to a coprocessor; and

the calculation result of the ALU being output to the ALU output supply line.

In this embodiment, the CPU can supply the calculation result of the ALU to the coprocessor at one operating clock signal of the CPU, for example. Specifically, processing using the coprocessor can be performed at high speed. In the case where the coprocessor performs calculation processing using the calculation result of the ALU, the CPU can supply the necessary information to the coprocessor at one clock signal, for example. Therefore, saturation processing can be performed at high speed, for example. The coprocessor can acquire the calculation result of the ALU in a period in which the CPU performs another processing.

According to one embodiment of the invention, there is provided an integrated circuit device having a CPU which performs given processing based on an instruction code,

the CPU including an ALU which performs calculation processing based on the instruction code;

the ALU including a flag register which stores flag data based on a calculation result;

the CPU including a flag data supply line used to supply an output from the flag register of the ALU to a coprocessor; and

the flag data stored in the flag register being output to the flag data supply line.

In this embodiment, the CPU can supply the flag data based on the calculation result of the ALU to the coprocessor at one operating clock signal of the CPU, for example. Specifically, processing using the coprocessor can be performed at high speed. In the case where the coprocessor performs calculation processing using the flag data of the ALU, the CPU can supply the necessary information to the coprocessor at one clock signal, for example. Therefore, saturation processing can be performed at high speed, for example. The coprocessor can acquire the flag data in a period in which the CPU performs another processing.

According to one embodiment of the invention, there is provided an integrated circuit device having a CPU which performs given processing based on an instruction code,

the CPU including:

a lord store section which reads data from a memory or writes data into the memory; and

a load data supply line used to supply data read from the memory by the lord store section to a coprocessor; and

the data read from the memory by the lord store section being output to the load data supply line.

In this embodiment, the CPU can supply the load data read from the memory by the lord store section to the coprocessor at one operating clock signal of the CPU, for example. Specifically, processing using the coprocessor can be performed at high speed. In the case where the coprocessor performs calculation processing using the load data, the CPU can supply the necessary information to the coprocessor at one clock signal, for example. The coprocessor can acquire the load data in a period in which the CPU performs another processing.

According to one embodiment of the invention, there is provided an integrated circuit device having a CPU which performs given processing based on an instruction code,

the CPU including:

a fetch section which fetches the instruction code;

a decode control section which decodes the instruction code fetched by the fetch section and outputs a control signal; and

a control signal supply line used to supply the control signal output from the decode control section to a coprocessor; and

the control signal output from the decode control section being output to the control signal supply line.

In this embodiment, the CPU can supply the control signal output from the decode control section to the coprocessor at one operating clock signal of the CPU, for example. Specifically, processing using the coprocessor can be performed at high speed.

According to one embodiment of the invention, there is provided an integrated circuit device having a CPU which performs given processing based on an instruction code,

the CPU including:

a fetch section including a program counter; and

a count value supply line used to supply a count value output from the program counter to a coprocessor;

the fetch section fetching the instruction code based on the count value output from the program counter; and

the count value of the program counter being output to the count value supply line.

In this embodiment, the CPU can supply the count value output from the program counter to the coprocessor at one operating clock signal of the CPU, for example. Specifically, processing using the coprocessor can be performed at high speed.

According to one embodiment of the invention, there is provided an integrated circuit device having a CPU which performs given processing based on an instruction code, and a coprocessor which performs given calculation processing based on data supplied from the CPU and outputs a calculation result to the CPU,

the CPU including:

a register file including a plurality of registers, each of which holds an address or data used for the given processing, and first to nth (n is an integer greater than one) register select circuits, each of which selects at least one arbitrary register from the plurality of registers and outputs a value stored in the selected register; and

first to nth register file supply lines used to supply an output from at least one of the first to nth register select circuits of the register file to the coprocessor.

In this embodiment, the CPU can supply the output from the register file to the coprocessor at one operating clock signal of the CPU, for example. Specifically, processing using the coprocessor can be performed at high speed. The CPU can supply the necessary information to the coprocessor at one clock signal, for example. The coprocessor can acquire the output from the register file in a period in which the CPU performs another processing.

According to one embodiment of the invention, there is provided an integrated circuit device having a CPU which performs given processing based on an instruction code, and a coprocessor which performs given calculation processing based on data supplied from the CPU and outputs a calculation result to the CPU,

the CPU including:

an immediate value generation section which generates immediate data based on the instruction code and outputs the generated immediate data; and

an immediate data supply line used to supply the immediate data output from the immediate value generation section to the coprocessor.

In this embodiment, the CPU can supply the immediate data output from the immediate value generation section to the coprocessor at one operating clock signal of the CPU, for example. Specifically, processing using the coprocessor can be performed at high speed. In the case where the coprocessor performs calculation processing using the immediate data, the CPU can supply the necessary information to the coprocessor at one clock signal, for example. The coprocessor can acquire the immediate data in a period in which the CPU performs another processing.

According to one embodiment of the invention, there is provided an integrated circuit device having a CPU which performs given processing based on an instruction code, and a coprocessor which performs given calculation processing based on data supplied from the CPU and outputs a calculation result to the CPU,

the CPU including:

an ALU which performs calculation processing based on the instruction code; and

an ALU output supply line used to supply a calculation result of the ALU to a coprocessor.

In this embodiment, the CPU can supply the calculation result of the ALU to the coprocessor at one operating clock signal of the CPU, for example. Specifically, processing using the coprocessor can be performed at high speed. In the case where the coprocessor performs calculation processing using the calculation result of the ALU, the CPU can supply the necessary information to the coprocessor at one clock signal, for example. The coprocessor can acquire the calculation result of the ALU in a period in which the CPU performs another processing.

According to one embodiment of the invention, there is provided an integrated circuit device having a CPU which performs given processing based on an instruction code, and a coprocessor which performs given calculation processing based on data supplied from the CPU and outputs a calculation result to the CPU,

the CPU including:

a lord store section which reads data from a memory or writes data into the memory; and

a load data supply line used to supply data read from the memory by the lord store section to the coprocessor.

In this embodiment, the CPU can supply the load data read from the memory by the lord store section to the coprocessor at one operating clock signal of the CPU, for example. Specifically, processing using the coprocessor can be performed at high speed. In the case where the coprocessor performs calculation processing using the load data, the CPU can supply the necessary information to the coprocessor at one clock signal, for example. The coprocessor can acquire the load data in a period in which the CPU performs another processing.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention. In the drawings, components denoted by the same reference numbers have the same meanings.

1. Integrated Circuit Device

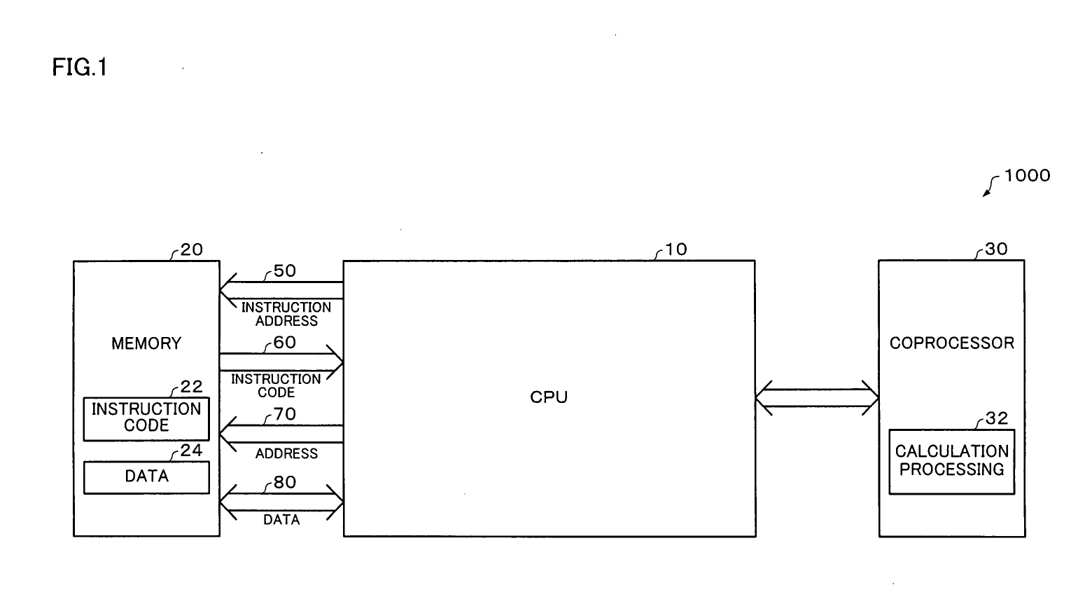

FIG. 1 is a configuration example of an integrated circuit device 1000 according to one embodiment of the invention. The integrated circuit device 1000 includes a central processing unit (CPU) 10, a memory 20, and a coprocessor 30. However, the configuration of the integrated circuit device 1000 is not limited thereto. For example, the integrated circuit device 1000 may have a configuration in which the memory 20 and the coprocessor 30 are omitted. The CPU 10 exchanges various types of information with the coprocessor 30. An instruction code 22 and data 24 processed by the CPU 10 are stored in the memory 20, for example.

The memory 20 receives an instruction address from the CPU 10 through an instruction address bus 50, and outputs the instruction code stored in the memory 20 to the CPU 10 through an instruction data bus 60 according to the instruction address, for example. The memory 20 receives a data address from the CPU 10 through a data address bus 70, and outputs the data 24 stored in the memory 20 to the CPU 10 through a data bus 80 according to the data address, for example. The CPU 10 performs various types of processing based on the information acquired from the memory 20 as described above. The memory 20 can also store data output from the CPU 10 through the data bus 80, for example.

The coprocessor 30 includes a calculation processing section 32 which can perform calculation in which the CPU 10 is weak at high speed. Specifically, the CPU 10 can efficiently perform processing by using the coprocessor 30 depending on the type of processing.

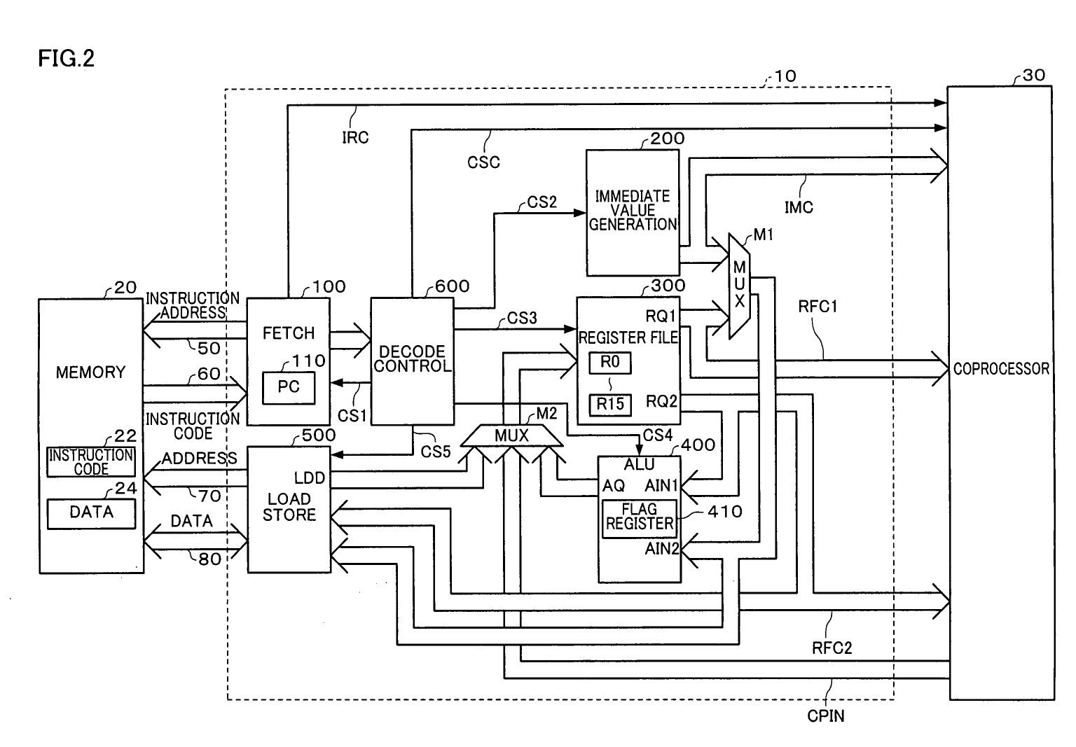

FIG. 2 is a configuration example of the integrated circuit device 1000 and the CPU 10 according to one embodiment of the invention. The CPU 10 includes a fetch section 100 which fetches an instruction, an immediate value generation section 200 which generates an immediate value, and a register file 300 which includes a plurality of registers. The CPU 10 also includes an arithmetic and logic unit (ALU) 400 which performs calculation, a lord store section 500 which reads or writes data, and a decode control section 600 which decodes the instruction fetched by the fetch section 100.

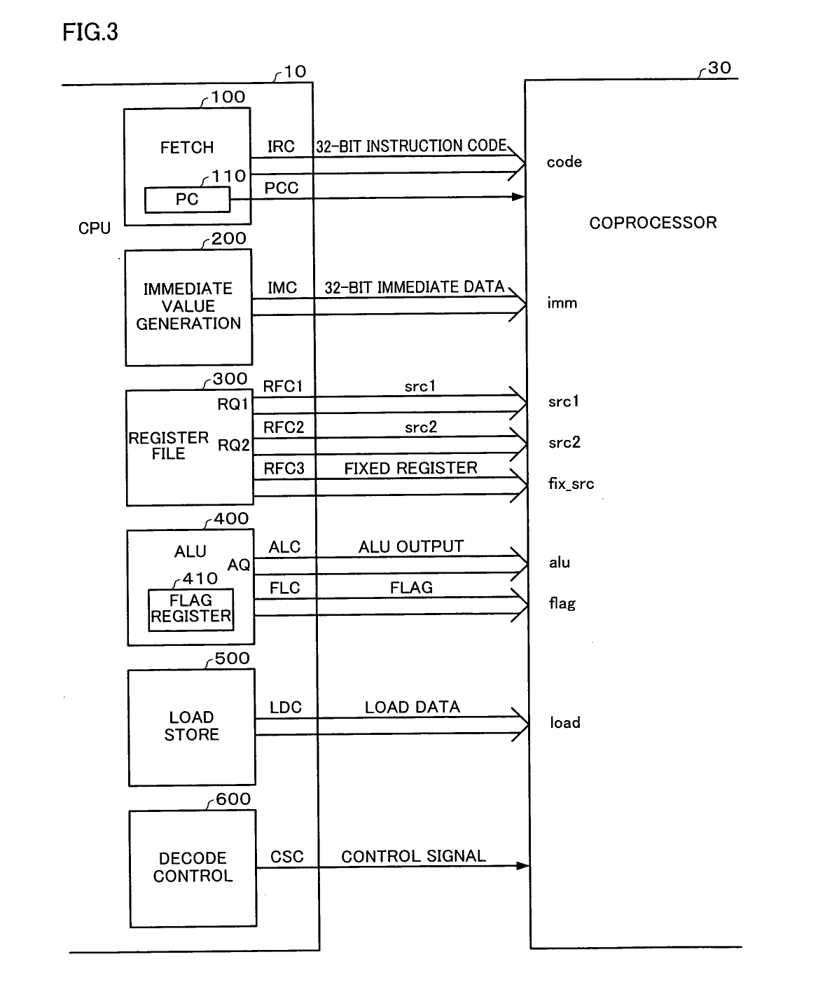

The integrated circuit device 1000 includes an instruction code supply line IRC for supplying an instruction code fetched by the fetch section 100 to the coprocessor 30, and an immediate data supply line IMC for supplying immediate data output from the immediate value generation section 200 to the coprocessor 30. The integrated circuit device 1000 includes first and second register file supply lines RFC1 and RFC2 (first to nth register file supply lines in a broad sense) for supplying outputs from first and second register select circuits 310 and 320 (first to nth register select circuits in a broad sense) of the register file 300 to the coprocessor 30, and a fixed register data supply line RFC3 for supplying an output from the register set as a fixed register to the coprocessor 30 (see FIG. 3, for example). The integrated circuit device 1000 includes an ALU output supply line ALC for supplying a calculation result of the ALU 400 to the coprocessor 30 (see FIG. 3, for example), and a flag data supply line FLC for supplying flag data stored in a flag register 410 of the ALU 400 to the coprocessor 30 (see FIG. 3, for example). The integrated circuit device 1000 includes a load data supply line LDC for supplying data read from the memory 20 by the lord store section 500 to the coprocessor 30 (see FIG. 3, for example), and a control signal supply line CSC for supplying a control signal from the decode control section 600 to the coprocessor 30.

The configuration of the integrated circuit device 1000 is not limited to the above-described configuration. For example, the CPU 10 may have a configuration in which the immediate data supply line IMC, the first and second register file supply lines RFC1 and RFC2, and the fixed register data supply line RFC3 are omitted. The coprocessor 30 outputs the calculation result of the coprocessor to the CPU 10 through a coprocessor data input line CPIN, for example.

The fetch section 100 fetches the instruction code 22 stored in the memory 20, for example. The fetch section 100 includes a program counter (PC) 110 which outputs a count value. When fetching an instruction, the fetch section 100 outputs an instruction address based on the count value output from the program counter 110 to the memory 20, for example. When fetching an instruction, the fetch section 100 outputs the value output from the program counter 110 to the memory 20 as an instruction address through the instruction address bus 50, for example. When fetching an instruction, the fetch section 100 may output the count value as an instruction address and then increment the count value of the program counter 110, or may output a value obtained by incrementing the count value of the program counter 110 as an instruction address, for example.

The fetch section 100 outputs the fetched instruction code 22 to the decode control section 600. The fetch section 100 is connected with one end of the instruction code supply line IRC, for example. The fetch section 100 may be connected with the coprocessor 30 through the instruction code supply line IRC. In this case, the fetch section 100 may supply the fetched instruction code 22 to the coprocessor 30 through the instruction code supply line IRC.

The program counter 110 of the fetch section 100 is connected with one end of a count value supply line PCC (see FIG. 3, for example) (omitted in FIG. 2). The program counter 110 may be connected with the coprocessor 30 through the count value supply line PCC. In this case, the program counter 110 of the fetch section 100 may supply the count value to the coprocessor 30 through the count value supply line PCC. The fetch section 100 fetches the next instruction based on a control signal CS1 from the decode control section 600, for example.

When an immediate value is included in the instruction code 22, the immediate value generation section 200 generates 32-bit immediate data based on a control signal CS2 output from the decode control section 600, for example. The immediate data generated by the immediate value generation section 200 is supplied to the ALU 400 and the lord store section 500 through a multiplexer (MUX) M1. The immediate value generation section 200 is connected with one end of the immediate data supply line IMC, for example. The immediate value generation section 200 may be connected with the coprocessor 30 through the immediate data supply line IMC. In this case, the immediate value generation section 200 may supply the generated immediate data (e.g. 32-bit immediate data) to the coprocessor 30 through the immediate data supply line IMC.

The register file 300 includes a plurality of registers such as sixteen registers R0 to R15. Each of the registers R0 to R15 is a 32-bit register, for example. The register file 300 selects an arbitrary register from the registers R0 to R15 based on a control signal CS3 output from the decode control section 600, and outputs a value stored in the selected register, for example.

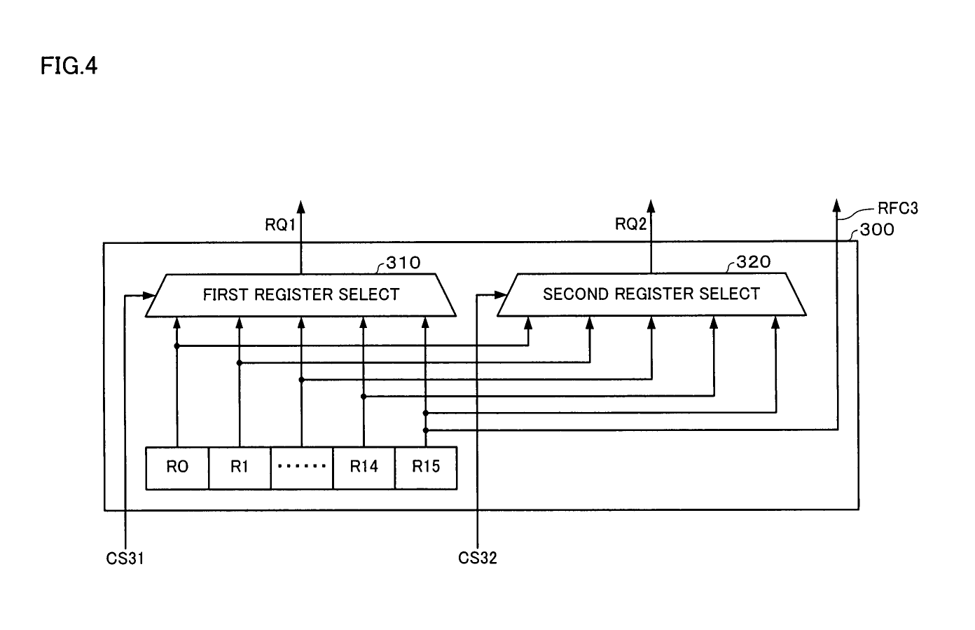

In more detail, the register file 300 includes a plurality of register select circuits connected with output terminals of the registers R0 to R15. Each register select circuit selects an arbitrary register from the registers R0 to R15, and outputs a value stored in the selected register. An output terminal RQ1 of a first register select circuit 310 (see FIG. 4) is connected with the multiplexer M1, for example. A value output from the output terminal RQ1 of the first register select circuit 310 is supplied to the ALU 400 and the lord store section 500 through the multiplexer M1. The output terminal RQ1 of the first register select circuit 310 is connected with one end of the register file supply line RFC1, for example. The output terminal RQ1 of the first register select circuit 310 of the register file 300 may be connected with the coprocessor 30 through the first register file supply line RFC1. In this case, the register file 300 may supply the value output from the output terminal RQ1 of the first register select circuit 310 to the coprocessor 30.

An output terminal RQ2 of a second register select circuit (nth register select circuit in a broad sense) 320 (see FIG. 4) is connected with the ALU 400 and the lord store section 500, for example. The second register select circuit 320 outputs a value stored in the register selected based on the control signal CS3 from the output terminal RQ2, for example. The output terminal RQ2 of the second register select circuit 320 may be connected with the coprocessor 30 through the second register file supply line RFC2. In this case, the register file 300 may supply the value output from the output terminal RQ2 of the second register select circuit 320 to the coprocessor 30.

At least one of the registers R0 to R15 of the register file 300 may be set as a fixed register. In this case, the fixed register is connected with one end of the fixed register data supply line RFC3 (omitted in FIG. 2), for example. In this case, the value output from one of the registers R0 to R15 of the register file 300 set as the fixed register may be supplied to the coprocessor 30.

The configuration of each register select circuit is not limited to the above-described configuration. For example, each register select circuit may select two or more arbitrary registers from the registers R0 to R15, and output data stored in each of the selected registers.

The ALU 400 includes a first ALU input terminal AIN1 and a second ALU input terminal AIN2, for example. A value output from the output terminal RQ2 of the second register select circuit 320 is input to the first ALU input terminal AIN1, and an output from the multiplexer M1 is input to the second ALU input terminal AIN2, for example. The ALU 400 performs calculation processing for the values input to the input terminals AIN1 and AIN2 based on a control signal CS4 output from the decode control section 600, and outputs the calculation result from an ALU output terminal AQ. The ALU output terminal AQ is connected with a multiplexer M2, for example.

The ALU output terminal AQ is connected with one end of the ALU output supply line ALC (see FIG. 3, for example) (omitted in FIG. 2). The ALU 400 may be connected with the coprocessor 30 through the ALU output supply line ALC. In this case, the output (e.g. calculation result) from the ALU 400 may be supplied to the coprocessor 30.

The ALU 400 includes a flag register 410. The flag register 410 stores flag data such as a carry flag C, overflow flag V, zero flag Z, and negative flag N. The output terminal of the flag register 410 is connected with one end of the flag register supply line FLC (see FIG. 3, for example) (omitted in FIG. 2). The flag register 410 of the ALU 400 may be connected with the coprocessor 30 through the flag register supply line FLC. In this case, the flag data C, V, Z, and N stored in the flag register 410 may be supplied to the coprocessor 30.

The lord store section 500 receives the value output from the multiplexer M1 or the value output from the output terminal RQ2 of the second register select circuit 320, and stores (writes) the value in the memory 20 based on a control signal CS5 output from the decode control section 600. The lord store section 500 reads data from the memory 20 based on the control signal CS5, and outputs the read data to the multiplexer M2 from a load data output terminal LDD, for example.

The load data output terminal LDD of the lord store section 500 is connected with one end of the load data supply line LDC (see FIG. 3, for example) (omitted in FIG. 2). The lord store section 500 may be connected with the coprocessor 30 through the load data supply line LDC. In this case, the output (e.g. data read from the memory) from the lord store section 500 may be supplied to the coprocessor 30.

The decode control section 600 receives the instruction code 22 from the fetch section 100, decodes the instruction code 22, generates control signals based on the decode result, and outputs the control signals CS1 to CS5. The decode control section 600 also generates signals (not shown) for controlling the multiplexers M1 and M2. The decode control section 600 is connected with one end of the control signal supply line CSC, for example. The decode control section 600 may be connected with the coprocessor 30 through the control signal supply line CSC. The decode control section 600 may supply the control signals CS1 to CS5 and the signals for controlling the multiplexers M1 and M2 to the coprocessor 30 through the control signal supply line CSC, for example.

The above-described configuration is an example of the configuration of the CPU 10. The configuration of the CPU 10 is not limited to the above-described configuration.

2. Connection Relationship of Each Section

FIG. 3 is a diagram illustrative of the connection relationship between the CPU 10 and the coprocessor 30.

For example, when the other end of the instruction code supply line IRC is connected with the coprocessor 30, the coprocessor 30 can receive the instruction code 22 (code) output from the fetch section 100. This allows the coprocessor 30 to acquire the instruction code 22 output from the fetch section 100 at one operating clock signal of the CPU 10. The instruction code 22 has a 32-bit configuration. However, the number of bits of the instruction code 22 is not limited thereto.

When the other end of the count value supply line PCC is connected with the coprocessor 30, the coprocessor 30 can receive the count value output from the program counter 110, for example. This allows the coprocessor 30 to acquire the count value output from the program counter 110 at one operating clock signal of the CPU 10.

When the other end of the immediate data supply line IMC is connected with the coprocessor 30, the coprocessor 30 can receive the immediate data (imm) output from the immediate value generation section 200, for example. This allows the coprocessor 30 to acquire the immediate data output from the immediate value generation section 200 at one operating clock signal of the CPU 10. The immediate value generation section 200 generates 32-bit immediate data, for example. However, the number of bits of immediate data is not limited thereto.

When the other end of the first register file supply line RFC1 is connected with the coprocessor 30, the coprocessor 30 can receive register data src1 output from the output terminal RQ1 of the first register select circuit 310, for example. This allows the coprocessor 30 to acquire the register data src1 output from the register file 300 at one operating clock signal of the CPU 10.

When the other end of the second register file supply line RFC2 is connected with the coprocessor 30, the coprocessor 30 can receive register data src2 output from the output terminal RQ2 of the second register select circuit 320, for example. This allows the coprocessor 30 to acquire the register data src2 output from the register file 300 at one operating clock signal of the CPU 10.

For example, when the register R15 of the registers R0 to R15 of the register file 300 is set as a fixed register, the output terminal of the register R15 is connected with one end of the fixed register data supply line RFC3. When the other end of the fixed register data supply line RFC3 is connected with the coprocessor 30, the coprocessor 30 can receive fixed register data fix_src output from the output terminal of the register R15, for example. This allows the coprocessor 30 to acquire the fixed register data fix_src output from the register file 300 at one operating clock signal of the CPU 10.

When the other end of the ALU output supply line ALC is connected with the coprocessor 30, the coprocessor 30 can receive the calculation result of the ALU 400 output from the ALU output terminal AQ, for example. This allows the coprocessor 30 to acquire the calculation result of the ALU 400 at one operating clock signal of the CPU 10.

When the other end of the flag data supply line FLC is connected with the coprocessor 30, the coprocessor 30 can receive the flag data C, V, Z, and N output from the flag register 410, for example. This allows the coprocessor 30 to acquire the flag data C, V, Z, and N based on the calculation result of the ALU 400 at one operating clock signal of the CPU 10. The flag register 410 stores the flag data C, V, Z, and N. Another piece of flag data may also be stored in the flag register 410. In this case, the flag register 410 may supply another piece of flag data to the coprocessor 30 through the flag data supply line FLC. The flag register 410 may collectively supply the flag data C, V, Z, and N to the coprocessor 30 as flag data “flag”.

When the other end of the load data supply line LDC is connected with the coprocessor 30, the coprocessor 30 can receive load data “load” output from the load data output terminal LDD, for example. This allows the coprocessor 30 to acquire the load data read from the memory 20 by the lord store section 500 at one operating clock signal of the CPU 10.

When the other end of the control signal line CSC is connected with the coprocessor 30, the coprocessor 30 can receive the control signal output from the decode control section 600, for example. This allows the coprocessor 30 to acquire the control signal generated by the decode control section 600 at one operating clock signal of the CPU 10.

FIG. 4 is a diagram showing a configuration example of the register file 300. The register file 300 includes the sixteen registers R0 to R15. However, the number of registers is not limited thereto. The number of registers provided in the register file 300 may be arbitrarily changed. The register file 300 includes the first and second register select circuits 310 and 320. However, the number of register select circuits is not limited thereto. The number of register select circuits provided in the register file 300 may be arbitrarily changed. In this case, the register file supply lines may be provided to the CPU 10 equivalent to the number of register select circuits.

The output terminals of the registers R0 to R15 are connected with the first and second register select circuits 310. The first register select circuit 310 selects one of the registers R0 to R15 based on a control signal CS31, and outputs a value stored in the selected register from the output terminal RQ1, for example. Likewise, the second register select circuit 320 selects one of the registers R0 to R15 based on a control signal CS32, and outputs a value stored in the selected register from the output terminal RQ2.

When the register R15 of the registers R0 to R15 is set as a fixed register, the output terminal of the register R15 is connected with the fixed register data supply line RFC3 without being connected with the first and second register select circuits 310 and 320.

The control signals CS31 and CS32 are generated by the decode control circuit 600, and may be included in the control signal CS3 shown in FIG. 2, for example. The decode control circuit 600 generates the control signals CS31 and CS32 according to the instruction code 22 from the fetch section 100, for example. The register file 300 selects the register based on the control signals CS31 and CS32, and outputs a value stored in the selected register.

3. Instruction Definition and Instruction Example

3.1 Instruction Definition

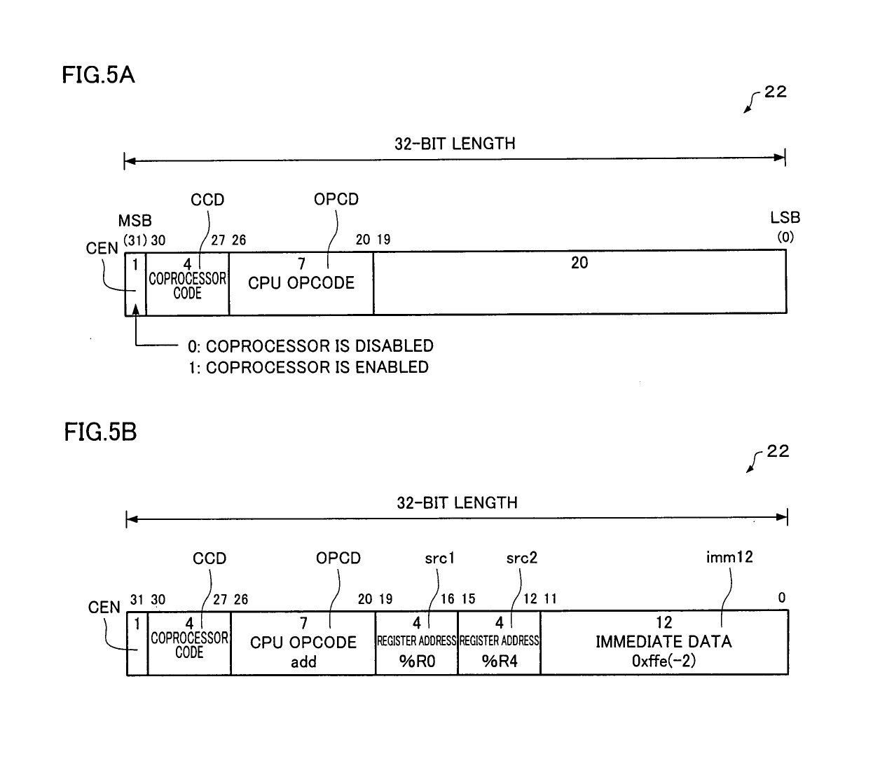

FIG. 5A is a diagram showing an example of the definition of the instruction code 22. The instruction code 22 includes a coprocessor enable bit CEN, a coprocessor code CCD, and a CPU opcode OPCD, for example. The coprocessor enable bit CEN indicates enabling or disabling of the coprocessor 30, the coprocessor code CCD indicates an instruction issued to the coprocessor 30, and the CPU opcode OPCD indicates an opcode for the CPU 10.

The instruction code 22 has a 32-bit configuration, for example. The 1-bit coprocessor enable bit CEN is set in the MSB (e.g. 31st bit), the 4-bit coprocessor code CCD is set in the 30th to 27th bits, and the 7-bit CPU opcode OPCD is set in the 26th to 20th bits, for example. The operation of the coprocessor 30 is enabled when the coprocessor enable bit CEN is set at “1”, and the operation of the coprocessor 30 is disabled when the coprocessor enable bit CEN is set at “0”, for example. In the instruction code 22, the remaining 20 bits (i.e. 19th bit to LSB (0th bit)) are arbitrarily used depending on the CPU opcode OPCD.

As shown in FIG. 5B, when an addition instruction “add” is set as the CPU opcode OPCD, the 19th to 16th bits and the 15th to 12th bits are used for register addresses, and the 11th to 0th bits are used for immediate data “imm12”, for example.

FIG. 5B shows an example of the instruction code 22 in which the coprocessor enable bit CEN is “1” and the CPU opcode OPCD is the addition instruction “add”. In this example, the address of the register R0 is set in the 19th to 16th bits of the instruction code 22, and the address of the register R4 is set in the 15th to 12th bits. The immediate data “imm12” in the 11th to 0th bits of the instruction code 22 is set at “0xffe” (“−2” in decimal number).

In this case, the operation of the coprocessor 30 is enabled based on the coprocessor enable bit CEN, so that the coprocessor 30 performs processing based on the coprocessor code CCD. In the CPU 10, the 12-bit immediate data “imm12” set at “0xffe” is sign-extended to 32-bit immediate data “imm” set at “0xfffffffe” by the immediate value generation section 200, for example. The ALU 400 adds the value stored in the register R4 and the 32-bit immediate data “imm” output from the immediate value generation section 200 (“% R4+0xfffffffe”).

The coprocessor 30 performs processing based on the coprocessor code CCD. The coprocessor 30 is connected with the CPU 10 through the supply lines IMC, RFC1 to RFC3, ALC, FLC, LDC, CSC, and the like. Therefore, the coprocessor 30 can acquire the extended 32-bit immediate data “imm” set at “0xfffffffe” and output from the immediate value generation section 200 at one operating clock signal of the CPU 10. The coprocessor 30 can also acquire the values stored in the registers R0 and R4 at one operating clock signal of the CPU 10. The coprocessor 30 can also acquire the value stored in the register R15 set as a fixed register at one operating clock signal of the CPU 10. The coprocessor 30 can also acquire the calculation result “% R4+0xfffffffe” of the ALU 400 at one operating clock signal of the CPU 10, and can acquire the flag data C, V, Z, and N based on the calculation result.

Since the coprocessor 30 can acquire the data from the CPU 10 at one operating clock signal of the CPU 10, the coprocessor 30 can perform complicated calculation using the acquired data at high speed.

The above-described configuration example of the instruction code 22 is only an example. The instruction may also be defined in another way.

3.2 Special Product-Sum Calculation Processing

An example in which the coprocessor 30 performs special product-sum calculation processing is described below.

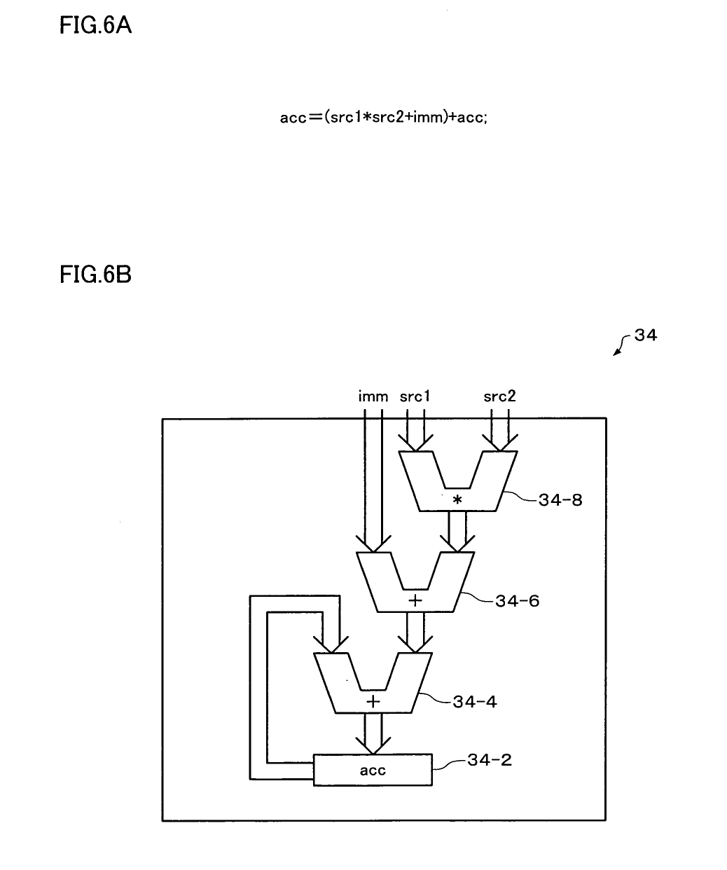

FIG. 6A is an example of a program showing special product-sum calculation processing. This program shows processing of adding the immediate data “imm” acquired from the CPU 10 and a value “acc” stored in an accumulation register 34-2 shown in FIG. 6B to the product of the register data “src1” and the register data “src2” acquired from the CPU 10, and storing the result in the accumulation register 34-2.

FIG. 6B is a configuration example of a calculation processing section 34 which performs the processing shown in FIG. 6A. The calculation processing section 34 includes the accumulation register 34-2, adders 34-4 and 34-6, and a multiplier 34-8. However, the configuration of the calculation processing section 34 is not limited thereto. The register data “src1” and “src2” is input to the multiplier 34-8, and the multiplication result is input to one input terminal of the adder 34-6. The immediate data “imm” is input to the other input terminal of the adder 34-6, and the adder 34-6 outputs the addition result to one input terminal of the adder 34-4. The value “acc” stored in the accumulation register 34-2 is input to the other input terminal of the adder 34-4, and the adder 34-6 stores the addition result in the accumulation register 34-2.

In one embodiment of the invention, when performing the processing shown in FIG. 6A, the calculation processing section 34 shown in FIG. 6B may be provided in the coprocessor 30. In one embodiment of the invention, since the immediate data “imm” and the register data “src1” and “src2” can be acquired from the CPU 10 at one operating clock signal of the CPU 10, the integrated circuit device 1000 which can perform the special product-sum calculation processing as shown in FIG. 6A at high speed can be designed by designing the circuit so that the calculation processing section 34 can perform the processing at one clock signal.

3.3 Saturation Processing

An example in which the coprocessor 30 performs saturation processing is described below.

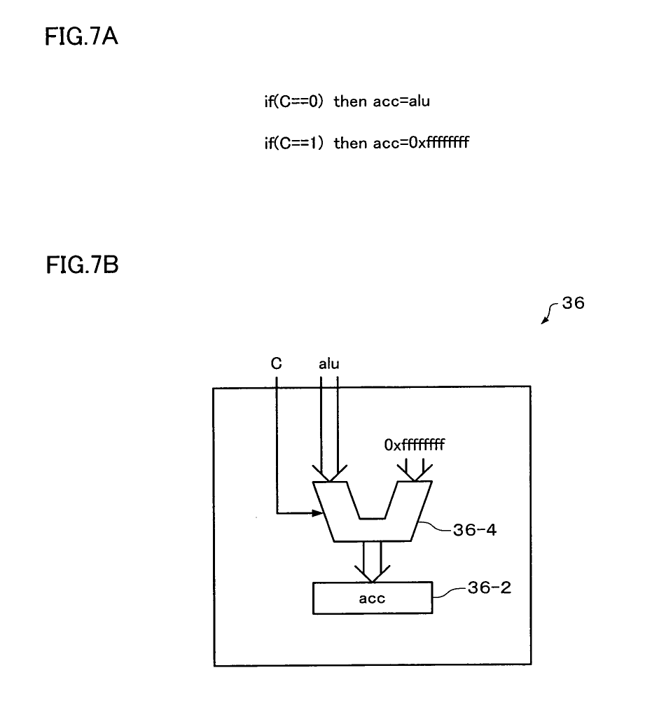

FIG. 7A is an example of a program showing saturation processing. This program shows processing of storing the calculation result “alu” of the ALU 400 in an accumulation register 36-2 shown in FIG. 7B when the flag data C acquired from the flag register 410 of the ALU 400 of the CPU 10 is “0”, and storing a value “0xffffffff” in the accumulation register 36-2 when the flag data C is “1”.

FIG. 7B is a configuration example of a calculation processing section 36 which performs the processing shown in FIG. 7A. The calculation processing section 36 includes the accumulation register 36-2 and a selector 34-4. However, the configuration of the calculation processing section 36 is not limited thereto. The value “0xfffffff” is input to one input terminal of the selector 36-4, and the calculation result “alu” acquired from the CPU 10 is input on the other input terminal. The flag data C acquired from the CPU 10 is input to the selector 36-4. The selector 36-4 stores either the value “0xfffffff” or the calculation result “alu” in the accumulation register 36-2 based on the flag data C. In more detail, the selector 36-4 stores the calculation result “alu” in the accumulation register 36-2 when the flag data C is “0”, and stores the value “0xffffffff” in the accumulation register 36-2 when the flag data C is “1”.

The flag data C becomes “1” when a carry has occurred in the calculation processing of the ALU 400. Specifically, the calculation result “alu” can be rounded off to the value “0xffffffff” when a carry has occurred. The calculation processing section 36 can perform such saturation processing (rounding processing).

In one embodiment of the invention, when performing the processing shown in FIG. 7A, the calculation processing section 36 shown in FIG. 7B may be provided in the coprocessor 30. In one embodiment of the invention, since the calculation result “alu” and the flag data C can be acquired from the CPU 10 at one operating clock signal of the CPU 10, the integrated circuit device 1000 which can perform the saturation processing as shown in FIG. 7A at high speed can be designed by designing the circuit so that the calculation processing section 36 can perform the processing at one clock signal.

3.4 Load Instruction

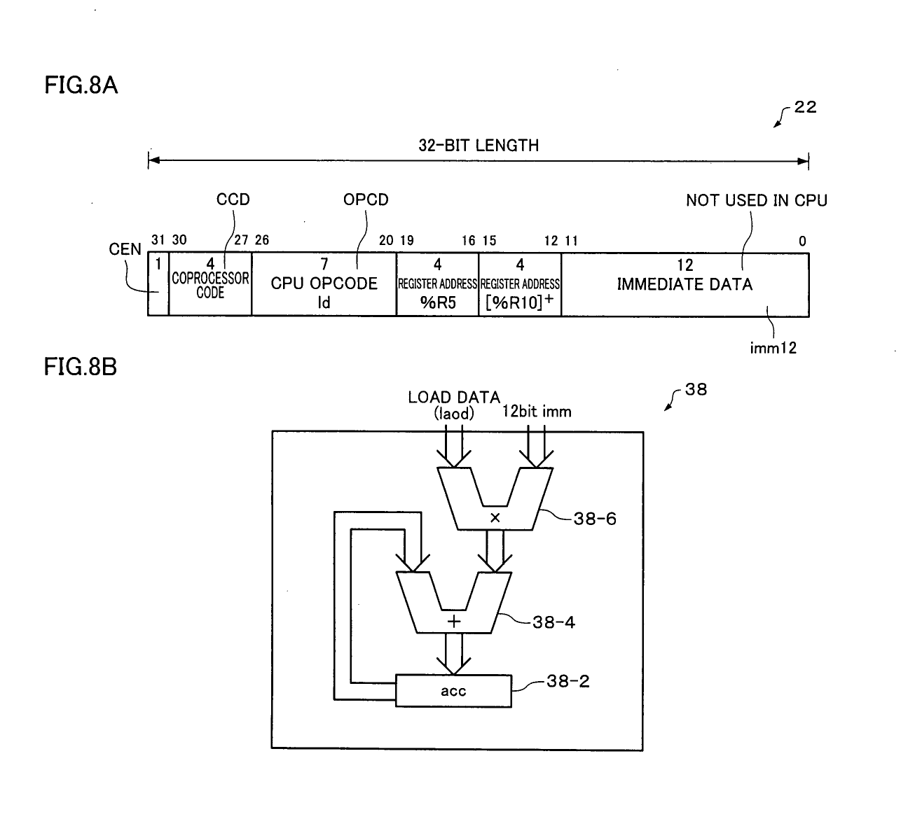

A load instruction “Id” is described below. FIG. 8A shows an example in which the load instruction “Id” is included in the instruction code 22.

For example, when the load instruction “Id” is set as the CPU opcode OPCD, the 19th to 16th bits and the 15th to 12th bits are used for register addresses. The CPU 10 does not use the 11th to 0th bits when the instruction is the load instruction “Id”.

In FIG. 8A, the coprocessor enable bit CEN is “1”, the address of the register R5 is set in the 19th to 16th bits of the instruction code 22, and the address of the register R10 is set in the 15th to 12th bits, for example. The 12-bit immediate data “imm12” is set in the 11th to 0th bits of the instruction code 22.

FIG. 8B is a diagram showing a configuration example of a calculation processing section 38 which performs calculation processing using a value read according to the load instruction “Id”. The calculation processing section 38 is provided in the coprocessor 30 and includes an accumulation register 38-2, an adder 384, and a multiplier 38-6. However, the configuration of the calculation processing section 38 is not limited thereto. The calculation processing section 38 performs calculation processing based on the 12-bit immediate data “imm12” included in the instruction code 22 and the value read according to the load instruction “Id”. In more detail, the multiplier 38-6 outputs the multiplication result of the 12-bit immediate data “imm12” and the value “load” read according to the load instruction “Id” to one input terminal of the adder 38-4. The adder 38-4 adds the value “acc” stored in the accumulation register 38-2 and the multiplication result of the multiplier 38-6, and stores the addition result in the accumulation register 38-2. The calculation processing section 38 can perform the above-described calculation processing at one operating clock signal of the CPU 10.

For example, when the instruction code 22 shown in FIG. 8A is fetched by the fetch section 100 of the CPU 10, the value read from the register R10 according to the load instruction “Id” is stored in the register R5 of the CPU 10, and the value stored in the register R10 is incremented. In more detail, the value stored in the register R10 is output to the lord store section 500, and the value “load” output from the load data output terminal LDD of the lord store section 500 is stored in the register R5. The immediate data “imm12” is not directly used in the CPU when the instruction is the load instruction “Id”.

The operation of the coprocessor 30 is enabled based on the coprocessor enable bit CEN, so that the coprocessor 30 performs processing based on the coprocessor code CCD. In this case, when the coprocessor code CCD of the instruction code 22 shown in FIG. 8A indicates the calculation processing by the calculation processing section 38 shown in FIG. 8B, the calculation processing section 38 performs the calculation processing. In more detail, the value stored in the register R10 is input to the multiplier 38-6 of the calculation processing section 38 through the load data supply line LDC shown in FIG. 3. The coprocessor 30 acquires the instruction code 22 through the instruction code supply line IRC. This allows the 12-bit immediate data “imm12” included in the instruction code 22 to be input to the multiplier 38-6 of the calculation processing section 38. The calculation processing section 38 performs the above-described calculation for the input values, and stores the calculation result in the accumulation register 38-2.

This processing may be used as processing of multiplying data read from the memory by fixed data while incrementing the data read from the memory and sequentially adding the multiplication result, for example. This processing is widely used for multimedia calculation processing. For example, the lower-order twelve bits of the instruction code 22 are not used when the instruction is the load instruction “Id”, as described above. By setting the immediate data “imm12” in the instruction code 22 by utilizing the unused area, data necessary for the calculation processing section 38 of the coprocessor 300 can be supplied to the coprocessor 30 by one instruction code 22. In one embodiment of the invention, since the coprocessor 30 is connected with the CPU 10 through the immediate data supply line IMC and the load data supply line LDC, the value “load” read according to the load instruction “Id” and the immediate data “imm12” set in the instruction code 22 can be acquired at one operating clock signal of the CPU 10. Therefore, according to one embodiment of the invention enables the above-described complicated calculation can be performed at high speed.

3.5 Extension Instruction

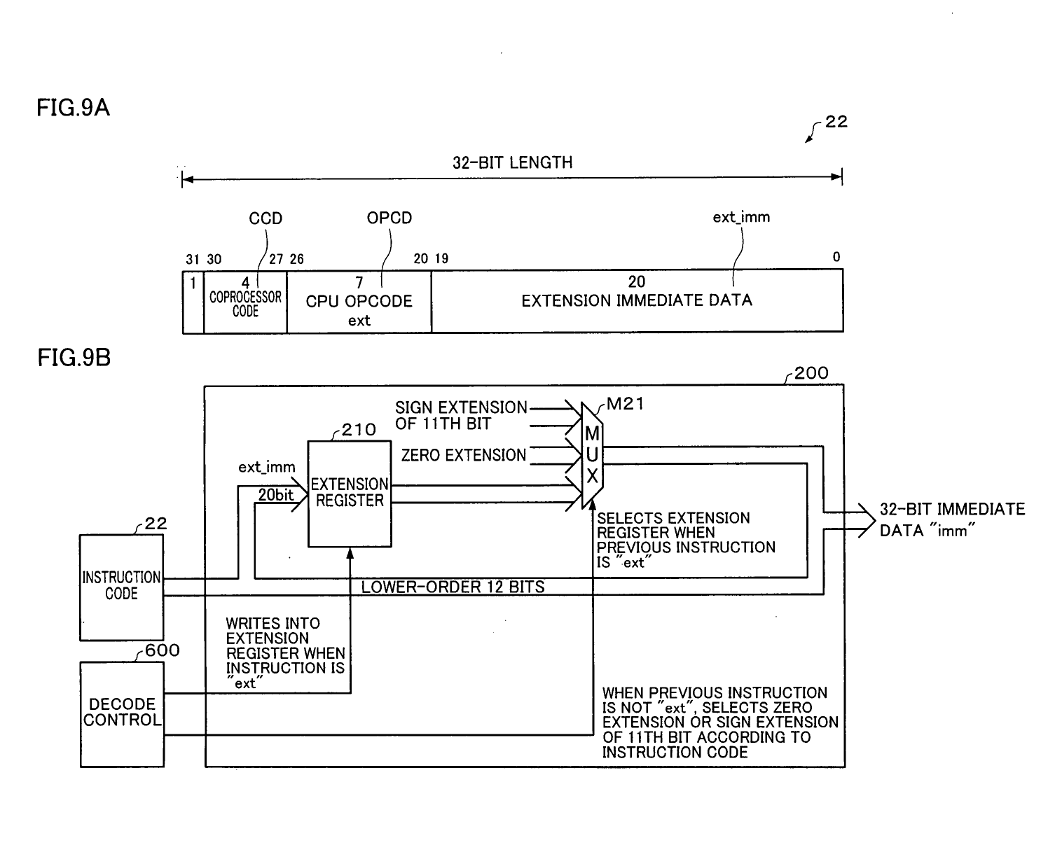

FIG. 9A shows an example of the instruction code 22 in which an extension instruction “ext” is set as the CPU opcode OPCD of the instruction code 22. The extension instruction “ext” includes 20-bit extension immediate data “ext_imm”, for example. The immediate value generation section 200 combines the 12-bit immediate data “imm12” included in the instruction code 22 subsequent to the extension instruction “ext” and the extension immediate data “ext_imm” based on the extension instruction “ext” to generate 32-bit immediate data “imm”, for example. Specifically, when arbitrary 32-bit immediate data “imm” is necessary, the extension instruction “ext” and the extension immediate data “ext_imm” may be set in the instruction code 22.

FIG. 9B is a block diagram showing the operation of the immediate value generation section 200 when generating the 32-bit immediate data “imm”. The immediate value generation section 200 includes an extension register 210 and a multiplexer M21. However, the configuration of the immediate value generation section 200 is not limited thereto. The extension register 210 can store the 20-bit extension immediate data “ext_imm”, for example.

For example, the lower-order 20 bits of the instruction code 22 are supplied to the extension register 210. In this case, when the extension instruction “ext” is set in the instruction code 22, the extension register 210 stores the lower-order 20 bits of the instruction code 22 based on the control signal from the decode control section 600, for example. Specifically, the extension register 210 stores the extension immediate data “ext_imm”.

The 12-bit immediate data “imm12” included in the next instruction code 22 is supplied to the immediate value generation section 200, and the multiplexer M21 selects the output from the extension register 210 when the extension instruction “ext” is set in the preceding instruction code 22. The 20-bit extension immediate data “ext_imm” selectively output from the multiplexer M21 is combined with the 12-bit immediate data “imm12”, and the combined data is output as the 32-bit immediate data “imm”.

When the extension instruction “ext” is not set in the preceding instruction code 22, the multiplexer M21 selects zero extension or sign extension according to the control signal generated by the decode control section 600 based on the instruction code 22. In more detail, the higher-order 20 bits of the 32-bit immediate data “imm” are set at “0” when zero extension is selected, and the higher-order 20 bits of the immediate data “imm” are set at a value based on the most significant bit of the 12-bit immediate data “imm12” when sign extension is selected, for example. In sign extension, the higher-order 20 bits of the 32-bit immediate data “imm” are set at “1” when the most significant bit of the 12-bit immediate data “imm12” is “1”, and the higher-order 20 bits of the immediate data “imm” are set at “0” when the most significant bit of the 12-bit immediate data “imm12” is “0”, for example.

In one embodiment of the invention, since the coprocessor 30 is connected with the CPU 10 through the immediate data supply line IMC, the coprocessor 30 can acquire the 32-bit immediate data “imm” complexly generated as described above at one operating clock signal of the CPU 10. Therefore, according to one embodiment of the invention, calculation using the 32-bit immediate data “imm” can be performed at high speed.

4. Comparison with Comparative Example

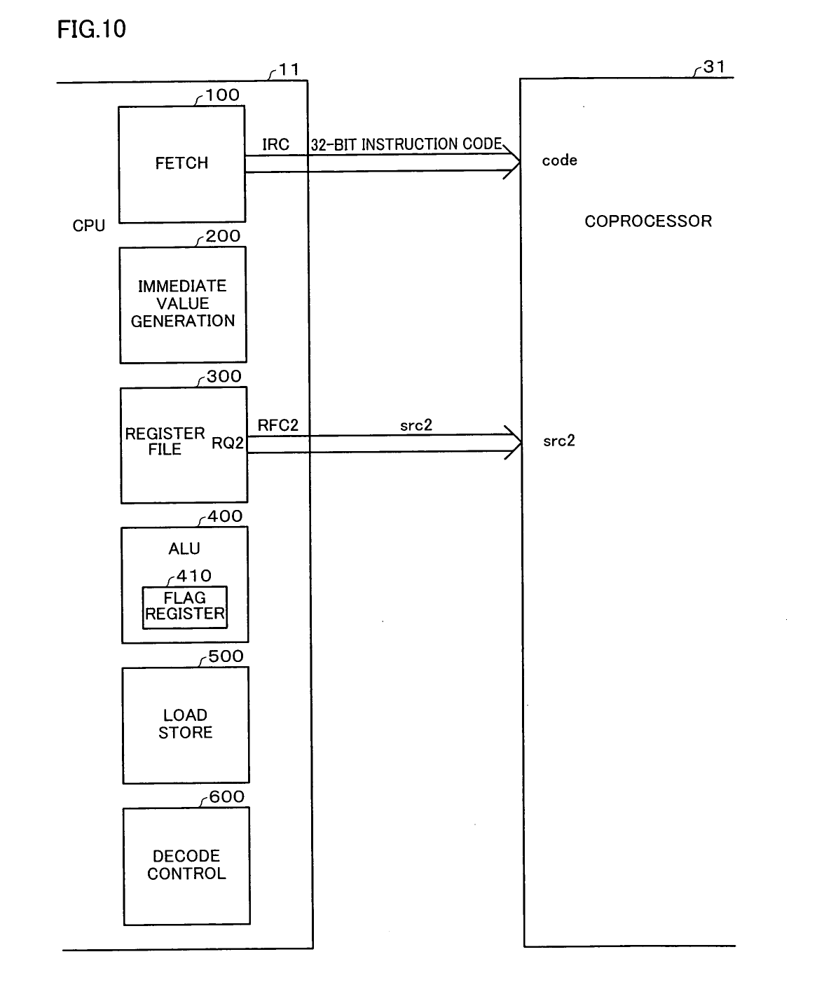

FIG. 10 is a diagram showing the connection relationship between a CPU 11 and a coprocessor 31 according to a comparative example of one embodiment of the invention. In the comparative example, the 32-bit instruction code 22 (code) output from the fetch section 100 is supplied to the coprocessor 31 through the instruction code supply line IRC, for example. The register data src2 output from the output terminal RQ2 of the register file 300 is supplied to the coprocessor 31 through the second register file supply line RFC2. For example, a value stored in one of the registers R0 to R15 of the register file 300 may be supplied to the coprocessor 31.

In the comparative example, when it is desired to supply the 32-bit immediate data “imm” to the coprocessor 31, the 32-bit immediate data “imm” must be supplied through the register file 300. In this case, since the CPU 11 must at least store the immediate data “imm” in the register file 300, the processing speed is decreased due to this processing. When it is desired to supply two types of data stored in the register file 300 to the coprocessor 31, the two types of data are individually supplied to the coprocessor 31, for example. This also results in a decrease in the processing speed.

When it is desired to supply the calculation result of the ALU 400 or the flag data to the coprocessor 31, the data must be supplied through the register file 300, so that the processing speed is decreased. Likewise, data must be supplied through the register file 300 when it is desired to supply the data output from the lord store section 500 to the coprocessor 31, so that the processing speed is decreased. In the comparative example, the control signal from the decode control section 600 cannot be directly supplied to the coprocessor 31.

In one embodiment of the invention, various types of data are supplied to the coprocessor 30 from the CPU 10 through the supply lines IMC, RFC1 to RFC3, ALC, FLC, LDC, CSC, and the like, as described above. Therefore, according to one embodiment of the invention, data or the like which should be supplied to the coprocessor 30 can be supplied to the coprocessor 30 at one operating clock signal of the CPU 10. Specifically, one embodiment of the invention can reduce a decrease in the processing speed in comparison with the comparative example. In one embodiment of the invention, since it is unnecessary to additionally provide a logic circuit block having a complicated hardware configuration differing from the comparative example, high-speed processing can be realized with a smaller circuit scale than that of the comparative example.

In the comparative example, when performing the complicated product-sum calculation processing shown in FIGS. 6A and 6B, since the immediate data “imm” and the register data “src1” and “src2” cannot be supplied to the coprocessor 31 at one clock signal, the processing shown in FIG. 6A cannot be realized using a simple configuration such as that of the calculation processing section 34 shown in FIG. 6B. In this case, the CPU 11 must perform processing of supplying the immediate data “imm”, processing of supplying the register data “src1”, and processing of supplying the register data “src2”. Therefore, when supplying the data “imm”, “src1”, and “src2” to the coprocessor 31, the comparative example requires time corresponding to at least two operating clock signals of the CPU 11 in order to perform the processing. Moreover, since necessary data is not supplied to the coprocessor 31 at one time, the circuit which receives the supplied data becomes complicated in the comparative example.

In one embodiment of the invention, the immediate data supply line IMC and the first and second register file supply lines RFC1 and RFC2 are connected with the coprocessor 30. Therefore, when performing the processing shown in FIG. 6A, the CPU 10 can supply the data “imm”, “src1”, and “src2” to the coprocessor 30 at one operating clock signal of the CPU 10. Specifically, the complicated product-sum calculation processing as shown in FIGS. 6A and 6B can be performed at high speed in comparison with the comparative example. It is also possible to reduce the circuit scale of the calculation processing section 34 of the coprocessor 30 in comparison with the comparative example.

In the comparative example, when performing the saturation processing as shown in FIGS. 7A and 7B, the calculation result “alu” of the ALU 400 and the flag data C stored in the flag register 410 of the ALU 400 cannot be supplied to the coprocessor 31 at one clock signal. Therefore, the processing shown in FIG. 7A cannot be realized by using a simple configuration such as that of the calculation processing section 36 shown in FIG. 7B. In this case, the CPU 11 must perform processing of supplying the calculation result “alu” and processing of supplying the flag data C. Therefore, when supplying the data “alu” and “C” to the coprocessor 31, the comparative example requires time corresponding to at least two operating clock signals of the CPU 11 in order to perform the processing. Moreover, since necessary data is not supplied to the coprocessor 31 at one time, the circuit which receives the supplied data becomes complicated in the comparative example.

In one embodiment of the invention, the ALU output supply line ALC and the flag data supply line FLC are connected with the coprocessor 30. Therefore, when performing the processing shown in FIG. 7A, the CPU 10 can supply the data “alu” and “C” to the coprocessor 30 at one operating clock signal of the CPU 10. Moreover, the calculation result “alu” can be supplied to the coprocessor 30 immediately after the value of the calculation result “alu” of the ALU 400 has been determined. Specifically, the saturation processing as shown in FIGS. 7A and 7B can be performed at high speed in comparison with the comparative example. It is also possible to reduce the circuit scale of the calculation processing section 36 of the coprocessor 30 in comparison with the comparative example.

In the comparative example, when performing the processing according to the load instruction shown in FIGS. 8A and 8B, since the load data “load” cannot be supplied to the coprocessor 31 at one clock signal, the processing shown in FIG. 8A cannot be realized by using a simple configuration such as that of the calculation processing section 38 shown in FIG. 8B. In this case, the CPU 11 must perform processing of supplying the 12-bit immediate data “imm12” and processing of supplying the load data “load”. Therefore, when supplying the data “load” and “imm12” to the coprocessor 31, the comparative example requires time corresponding to at least two operating clock signals of the CPU 11 in order to perform the processing. Moreover, since necessary data is not supplied to the coprocessor 31 at one time, the circuit which receives the supplied data becomes complicated in the comparative example.

In one embodiment of the invention, the instruction code supply line IRC and the load data supply line LDC are connected with the coprocessor 30. Therefore, when performing the processing shown in FIG. 8A, the CPU 10 can supply the data “load” and “imm12” to the coprocessor 30 at one operating clock signal of the CPU 10. Specifically, the complicated product-sum calculation processing as shown in FIGS. 8A and 8B can be performed at high speed in comparison with the comparative example. It is also possible to reduce the circuit scale of the calculation processing section 38 of the coprocessor 30 in comparison with the comparative example.

As described above, since the integrated circuit device 1000 according to one embodiment of the invention can supply necessary data to the coprocessor 30 at one clock signal without additionally providing a complicated logic circuit block differing from the comparative example, the complicated product-sum calculation processing can be performed at high speed in comparison with the comparative example.

The coprocessor 30 operates at a clock frequency the same as that of the CPU 10. However, the coprocessor 30 may operate at a clock frequency differing from that of the CPU 10.

5. Modification

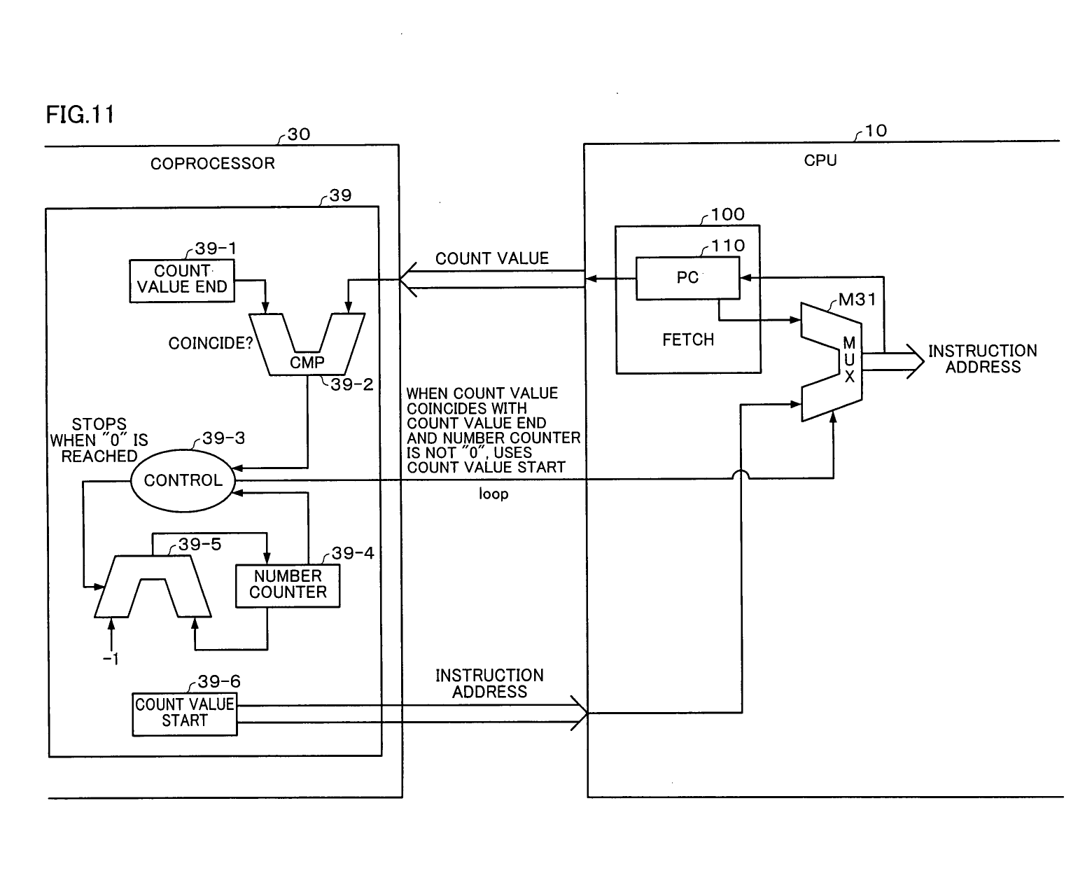

FIG. 11 is a diagram showing a modification of the integrated circuit device according to one embodiment of the invention. The integrated circuit device shown in FIG. 11 can perform loop processing at high speed. The coprocessor 30 may include a calculation processing section 39. The calculation processing section 39 includes a count value end 39-1, a comparator 39-2, a control section 39-3, a number counter 39-4, a subtractor 39-5, and a count value start 39-6. However, the configuration of the calculation processing section 39 is not limited thereto. For example, the subtractor 39-5 may be an adder. The CPU 10 may include the multiplexer M31.

The calculation processing section 39 receives the count value from the CPU 10, and compares the count value end 39-1 and the count value using the comparator 39-2. The count value end 39-1 indicates the count value when one loop processing ends. When the comparator 39-2 has determined that the count value end 39-1 coincides with the count value, the control section 39-3 outputs a loop processing signal “loop” to the CPU 10 based on the value output from the number counter 39-4. In more detail, when the value output from the number counter 39-4 is not “0”, the control section 39-3 sets the loop processing signal “loop” to be a signal which causes the multiplexer M31 of the CPU 10 to selectively output an instruction address output from the coprocessor 30. The control section 39-3 causes the subtractor 39-5 to perform subtraction processing of the value stored in the number counter 39-4.

On the other hand, when the value output from the number counter 39-4 is “0”, the control section 39-3 stops the subtraction processing of the subtractor 39-5 and sets the loop processing signal “loop” to be a signal which causes the multiplexer M31 to selectively output an instruction address output from the program counter 110 of the CPU 10. The count value start 39-6 indicates the count value at which the loop processing starts.

The multiplexer M31 selectively outputs the instruction address output from the program counter 110 or the instruction address output from the coprocessor 30 as the instruction address based on the loop processing signal “loop” from the coprocessor 30. In this case, a value obtained by incrementing the value stored in the program counter 110 by a predetermined value is input to the multiplexer M31. The instruction address output from the multiplexer M31 is output to the memory 20 and the program counter 110, for example. The program counter 110 stores the value output from the multiplexer M31 as the count value.

The CPU 10 sequentially processes the instruction code 22 while incrementing the count value indicated by the count value start. The multiplexer M31 changes the instruction address to be output based on the loop processing signal “loop” from the coprocessor 30. Specifically, when the coprocessor 30 has determined that one loop has been completed, the loop processing signal “loop” is set to be a signal which causes the multiplexer M31 to select the output from the count value start 39-6. This causes the value of the count value start 39-6 to be output from the multiplexer M31, and causes the value of the count value start 39-6 to be also stored in the program counter 110. The loop processing starts again in this manner. The number of loops may be determined based on the value set in the number counter 39-4.

In the comparative example shown in FIG. 10, when performing the loop processing, the counter for performing a loop n times is decremented after performing the loop processing. The counter value is then determined, and a branch instruction is issued based on the determination result, for example. Specifically, the comparative example requires at least an additional three to four instructions in order to perform the loop processing.

On the other hand, the integrated circuit device shown in FIG. 11 can perform the loop processing at high speed. The CPU 10 performs the loop processing, but need not perform processing for performing the loop processing (e.g. processing of determining completion of the loop processing). In the integrated circuit device shown in FIG. 11, the count value of the program counter 110 is supplied to the coprocessor 30. Specifically, the coprocessor 30 can control the count value of the program counter 110 based on the count value output from the program counter 110. Therefore, the CPU 10 can omit the processing necessary in the comparative example.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention. For example, any term cited with a different term having broader or the same meaning at least once in this specification or drawings can be replaced by the different term in any place in this specification and drawings.

What is claimed is:

1. An integrated circuit device having a CPU which performs given processing based on an instruction code,
the CPU including:
a fetch section which fetches the instruction code;
a register file including a plurality of registers and first to nth (n is an integer greater than one) register select circuits each of which selects at least one arbitrary register from the registers and outputs a value stored in the selected register;
an immediate value generation section which generates immediate data based on the instruction code and outputs the generated immediate data;
an instruction code supply line used to supply the instruction code fetched by the fetch section to a coprocessor;
first to nth register file supply lines used to supply the output from at least one of the first to nth register select circuits of the register file to the coprocessor; and
an immediate data supply line used to supply the output from the immediate value generation section to the coprocessor;
each of the registers storing an address or data used for the given processing;
the fetch section outputting the fetched instruction code to the instruction code supply line;
the outputs from the first to nth register select circuits of the register file being output to the first to nth register file supply lines; and
the immediate value generation section outputting the immediate data to the immediate data supply line.

2. An integrated circuit device having a CPU which performs given processing based on an instruction code,
the CPU including:
an ALU which performs calculation processing based on the instruction code;
an ALU output supply line used to supply a calculation result of the ALU to a coprocessor; and
a flag data supply line used to supply an output from a flag register which stores flag data based on the calculation result of the ALU to the coprocessor;
the calculation result of the ALU being output to the ALU output supply line; and
the flag data stored in the flag register being output to the flag data supply line.

3. An integrated circuit device having a CPU which performs given processing based on an instruction code,
the CPU including:
an immediate value generation section which generates immediate data based on the instruction code and outputs the generated immediate data;
a lord store section which reads data from a memory or writes data into the memory;
an immediate data supply line used to supply the output from the immediate value generation section to a coprocessor; and
a load data supply line used to supply data read from the memory by the lord store section to the coprocessor;
the immediate value generation section outputting the immediate data to the immediate data supply line; and
the lord store section outputting the data read from the memory to the load data supply line.

4. An integrated circuit device having a CPU which performs given processing based on an instruction code,
the CPU including:
a fetch section which fetches the instruction code;
a register file including a plurality of registers and first to nth (n is an integer greater than one) register select circuits each of which selects at least one arbitrary register from the plurality of registers and outputs a value stored in the selected register;
an instruction code supply line used to supply the instruction code fetched by the fetch section to a coprocessor; and
first to nth register file supply lines used to supply the output from at least one of the first to nth register select circuits of the register file to the coprocessor;
each of the registers storing an address or data used for the given processing;
the fetch section outputting the fetched instruction code to the instruction code supply line; and
the outputs from the first to nth register select circuits of the register file being output to the first to nth register file supply lines.

5. An integrated circuit device having a CPU which performs given processing based on an instruction code,
the CPU including:
a register file including a plurality of registers; and
a fixed register data supply line used to supply an output from a register of the plurality of registers set as a fixed register to a coprocessor; and
the fixed register storing an address or data used for the given processing; and
a value stored in the fixed register being output to the fixed register data supply line.

6. An integrated circuit device having a CPU which performs given processing based on an instruction code,
the CPU including:
an immediate value generation section which generates immediate data based on the instruction code and outputs the generated immediate data; and
an immediate data supply line used to supply the output from the immediate value generation section to a coprocessor; and
the immediate value generation section outputting the immediate data to the immediate data supply line.

7. An integrated circuit device having a CPU which performs given processing based on an instruction code,
the CPU including:
an ALU which performs calculation processing based on the instruction code and outputs a calculation result; and
an ALU output supply line used to supply the calculation result of the ALU to a coprocessor; and
the calculation result of the ALU being output to the ALU output supply line.

8. An integrated circuit device having a CPU which performs given processing based on an instruction code,
the CPU including an ALU which performs calculation processing based on the instruction code;
the ALU including a flag register which stores flag data based on a calculation result;
the CPU including a flag data supply line used to supply an output from the flag register of the ALU to a coprocessor; and
the flag data stored in the flag register being output to the flag data supply line.

9. An integrated circuit device having a CPU which performs given processing based on an instruction code,
the CPU including:
a lord store section which reads data from a memory or writes data into the memory; and
a load data supply line used to supply data read from the memory by the lord store section to a coprocessor; and
the data read from the memory by the lord store section being output to the load data supply line.

10. An integrated circuit device having a CPU which performs given processing based on an instruction code,
the CPU including:
a fetch section which fetches the instruction code;
a decode control section which decodes the instruction code fetched by the fetch section and outputs a control signal; and
a control signal supply line used to supply the control signal output from the decode control section to a coprocessor; and
the control signal output from the decode control section being output to the control signal supply line.

11. An integrated circuit device having a CPU which performs given processing based on an instruction code,
the CPU including:
a fetch section including a program counter; and
a count value supply line used to supply a count value output from the program counter to a coprocessor;
the fetch section fetching the instruction code based on the count value output from the program counter; and
the count value of the program counter being output to the count value supply line.

12. An integrated circuit device having a CPU which performs given processing based on an instruction code, and a coprocessor which performs given calculation processing based on data supplied from the CPU and outputs a calculation result to the CPU,
the CPU including:
a register file including a plurality of registers, each of which holds an address or data used for the given processing, and first to nth (n is an integer greater than one) register select circuits, each of which selects at least one arbitrary register from the plurality of registers and outputs a value stored in the selected register; and
first to nth register file supply lines used to supply an output from at least one of the first to nth register select circuits of the register file to the coprocessor.

13. An integrated circuit device having a CPU which performs given processing based on an instruction code, and a coprocessor which performs given calculation processing based on data supplied from the CPU and outputs a calculation result to the CPU,
the CPU including:
an immediate value generation section which generates immediate data based on the instruction code and outputs the generated immediate data; and
an immediate data supply line used to supply the immediate data output from the immediate value generation section to the coprocessor.

14. An integrated circuit device having a CPU which performs given processing based on an instruction code, and a coprocessor which performs given calculation processing based on data supplied from the CPU and outputs a calculation result to the CPU,
the CPU including:
an ALU which performs calculation processing based on the instruction code; and
an ALU output supply line used to supply a calculation result of the ALU to a coprocessor.

15. An integrated circuit device having a CPU which performs given processing based on an instruction code, and a coprocessor which performs given calculation processing based on data supplied from the CPU and outputs a calculation result to the CPU,
the CPU including:
a lord store section which reads data from a memory or writes data into the memory; and
a load data supply line used to supply data read from the memory by the lord store section to the coprocessor.

16. An integrated circuit device having a CPU which performs given processing based on an instruction code,
the CPU including:
a fetch section which fetches the instruction code;
a register file including a plurality of registers and first to nth (n is an integer greater than one) register select circuits each of which selects at least one arbitrary register from the registers and outputs a value stored in the selected register, each of the registers storing an address or data used for the given processing;
an immediate value generation section which generates immediate data based on the instruction code and outputs the generated immediate data;
an instruction code supply line used to supply the instruction code fetched by the fetch section to a coprocessor, the instruction code fetched by the fetch section being output to the instruction code supply line;
first to nth register file supply lines used to supply the output from at least one of the first to nth register select circuits of the register file to the coprocessor, the outputs from the first to nth register select circuits of the register file being output to the first to nth register file supply lines; and
an immediate data supply line used to supply the output from the immediate value generation section to the coprocessor, the immediate data generated by the immediate value generation section being output to the immediate data supply line.
